(19) United States
(12) Patent Application Publication
(10) Pub. No.: US 2018/0105329 A1
(43) Pub. Date: Apr. 19, 2018

(54) ANTI-REVERSAL STRUCTURE OF STATIONERY CONTAINER AND COVER

(71) Applicant: MCAIDE ENTERPRISE CO., LTD., New Taipei City (TW)

(72) Inventor: MING-HUA YEN, NEW TAIPEI CITY (CN)

(21) Appl. No.: 15/296,029

(22) Filed: Oct. 17, 2016

(51) Int. Cl. B65D 41/04; B65D 47/06; B65D 43/02; B43K 5/02

(52) U.S. Cl. CPC B65D 41/0471; B43K 5/02; B65D 43/0225; B65D 47/06

(57) ABSTRACT

An anti-reversal structure of a stationery container and a cover is provided. The cover is screwed to the stationery container to seal the stationery container for containing a functional solution. The anti-reversal structure includes a first ratchet portion disposed at one side of a threaded portion of the cover and a second ratchet portion disposed at one side of a threaded portion of the stationery container.

### FIELD OF THE INVENTION

The present invention relates to a stationery container for containing a functional solution, and more particularly to an anti-reversal structure of a stationery container and a cover. After the cover is screwed to the stationery container, it is locked immediately. The present invention can prevent the cover from reversal and disengagement and lower the manufacture cost.

### BACKGROUND OF THE INVENTION

Stationery containers, such as correction fluid containers (as shown in U.S. Pat. No. D648798), glue containers, and marker pens, are used to contain different functional solutions, such as correction fluid, glue, ink, and the like. For the use and convenience of storage, a cover is provided to seal the opening of the stationery container, preventing the functional solutions from deteriorating because of mixing with the air and preventing the functional solutions from leaking to cause pollution. A valve or a nozzle may be provided as a switch to open/close the functional solutions and to control the flow of the functional solutions. Therefore, the design of the cover is quite important for the containers filled with a functional solution.

The existing covers use threads, engaging buckles or a close-fitting way to retain the covers, and the covers are designed according to a desired retaining effect. The retaining way by threads is the most popular because its structure is simple and the retaining effect is good. In order to prevent the cover from being turned reversely to disengage from the container, the cover is formed with more threads for a tight connection. Alternatively, the opening of the container is applied with glue. These ways increase the manufacture cost and time. Accordingly, the inventor of the present invention has devoted himself based on his many years of practical experiences to solve these problems.

### SUMMARY OF THE INVENTION

In view of this, the primary object of the present invention is to provide an anti-reversal structure of a stationery container and a cover. The stationery container and the cover have threaded portions and two opposite ratchet portions disposed at the threaded portions in a direction opposite to the turning direction of the threaded portions. When the cover is screwed to the stationery container, the two ratchet portions hold against each other to be locked. The present invention can prevent the cover from reversal and disengagement and enhance the stability of assembly and use greatly.

In order to achieve the above object, the anti-reversal structure of the present invention provides various embodiments. The stationery container is provided with a first threaded portion and a first ratchet portion is disposed at one side of the first threaded portion. The cover is provided with a second threaded portion and a second ratchet portion is disposed at one side of the second threaded portion. The two opposite ratchet portions have a guide surface and a stop surface respectively. When the cover is screwed to the stationery container, the two guide surfaces are disposed face-to-face so that the cover can be screwed to the stationery container smoothly and conveniently. If the cover is turned reversely, the two opposite stop surfaces abut against each other to be locked, preventing the cover from reversal and disengagement after retained. In a first embodiment, the first threaded portion is located on an outer wall surface, and the second threaded portion is located on an inner wall surface of the cover. The first ratchet portion is located in proximity to the first threaded portion close to an opening of the stationery container. The first ratchet portion and the first threaded portion have different diameters to form a step. The second ratchet portion is located on the stationery container close to a bottom side of the second threaded portion. The second ratchet portion and the second threaded portion have different diameters to form a step. In a second embodiment, the first ratchet portion is located in proximity to the first threaded portion and away from an opening of the stationery container. The first ratchet portion and the first threaded portion have different diameters to form a step. The second ratchet portion is located on the cover and close to an opening of the cover. The second ratchet portion and the second threaded portion have different diameters to form a step. In the first and second embodiments, between the first ratchet portion and the first threaded portion is the step to form a step configuration, and between the second ratchet portion and the second threaded portion is another step configuration. In a third embodiment, the first ratchet portion is located at an end face of the stationery container, the second ratchet portion is located between the second threaded portion and a fluid drain valve. In a fourth embodiment, the first ratchet portion is arranged in the form of two sections and disposed at opposite sides of the first threaded portion respectively. The second ratchet portion is arranged in the form of two sections and disposed at opposite sides of the second threaded portion respectively. The first ratchet portion and the first threaded portion have different diameters to form a step. The second ratchet portion and the second threaded portion have different diameters to form a step. In this embodiment, between the two-section first ratchet portion and the first threaded portion is the stop to form a step configuration, and between the two-section second ratchet portion and the second threaded portion is another step configuration.

Furthermore, in another modified embodiment on the same principle, the cover has an inner tube therein, and the inner tube is inserted into an opening of the stationery container. The first ratchet portion is disposed on an outer wall surface of the inner tube, and the second ratchet portion is disposed on an inner wall surface of an opening of the stationery container.

### BRIEF DESCRIPTION OF THE DRAWINGS

FIG. 1 is a schematic view in accordance with a first embodiment of the present invention;

FIG. 2 is a schematic view in accordance with a second embodiment of the present invention;

FIG. 3 is a schematic view in accordance with a third embodiment of the present invention;

FIG. 4 is a schematic view in accordance with a fourth embodiment of the present invention; and

FIG. 5 is a schematic view in accordance with a fifth embodiment of the present invention.

### DESCRIPTION OF THE PREFERRED EMBODIMENTS

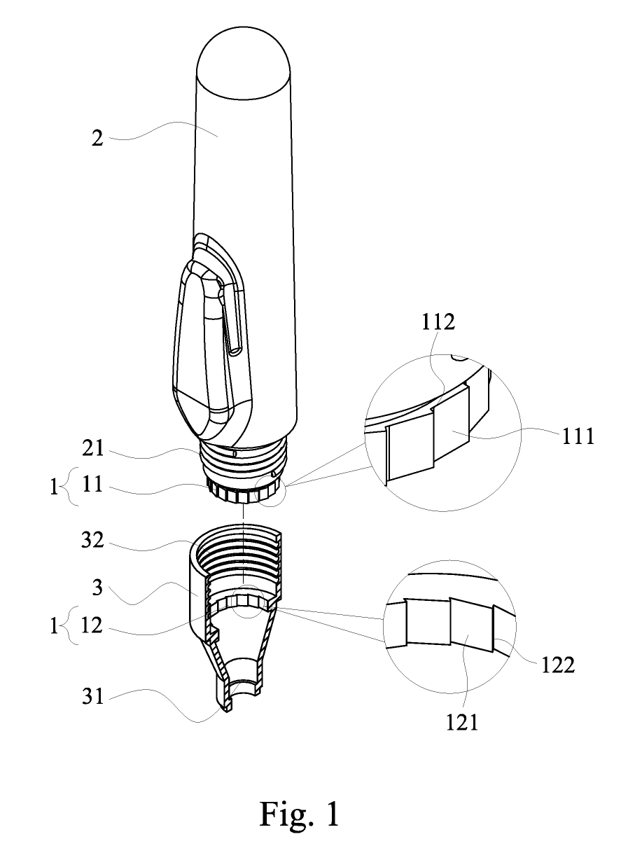

FIG. 1 is a schematic view in accordance with a first embodiment of the present invention. As shown in FIG. 1, the anti-reversal structure 1 of the present invention is applied to a stationery container 2 for containing correction fluid (functional solution). The stationery container 2 is sealed with a cover 3. A front end of the cover 3 is provided with a fluid drain valve 31. The first threaded portion is located on an outer wall surface of the stationery container close to an opening of the stationery container, and the second threaded portion is located on an inner wall surface of the cover. The first threaded portion 21 is screwed to the second threaded portion 32, such that the cover 3 is to seal the stationery container 2 totally. The anti-reversal structure 1 comprises a first ratchet portion 11 and a second ratchet portion 12.

The first ratchet portion 11 is located in proximity to the first threaded portion 21 close to an opening of the stationery container 2. One surface of the first ratchet portion 11 is a first guide surface 111 corresponding in direction to a screw-in direction of the first threaded portion 21. Another surface of the first ratchet portion 11 is a first stop surface 112 corresponding in direction to a screw-out direction of the first threaded portion 21. The cross-section of the first ratchet portion 11 is substantially in a triangular shape. The first ratchet portion 11 and the first threaded portion 21 have different diameters to form a step. That is to say, the first ratchet portion 11 and the first threaded portion 21 form two discontinuous planes to constitute a step configuration, or two continuous planes to constitute an inclined configuration having an included angle, or a non-planar configuration. In the present invention, they are a step configuration.

The second ratchet portion 12 is located on the cover 3 and between the second threaded portion 32 and a fluid drain valve 31. One surface of the second ratchet portion 12 is a second guide surface 121 corresponding in direction to a screw-in direction of the second threaded portion 32. Another surface of the second ratchet portion 12 is a second stop surface 122 corresponding in direction to a screw-out direction of the second threaded portion 32. The cross-section of the second ratchet portion 12 is substantially in a triangular shape. The second ratchet portion 12 and the second threaded portion 32 have different diameters to form a step. That is to say, a step configuration is also formed between the second ratchet portion 12 and the second threaded portion 32. When the cover 3 is screwed to the stationery container 2, the cover 3 can be turned smoothly provided by the first guide surface 111 and the second guide surface 121. When the user wants to turn the cover 3 reversely, the first stop surface 112 and the second stop surface 122 hold against each other to be locked. Thus, the present invention can prevent the cover 3 from being turned reversely. There is no need for applying an additional turning and additional adhesive to retain the cover. It is noted that the number of the first ratchet portion 11 and the second ratchet portion 12 can be changed according to the demand, or they can be formed in an encircling manner. The number of the first ratchet portion 11 and the second ratchet portion 12 is proportional to the lock force when retained.

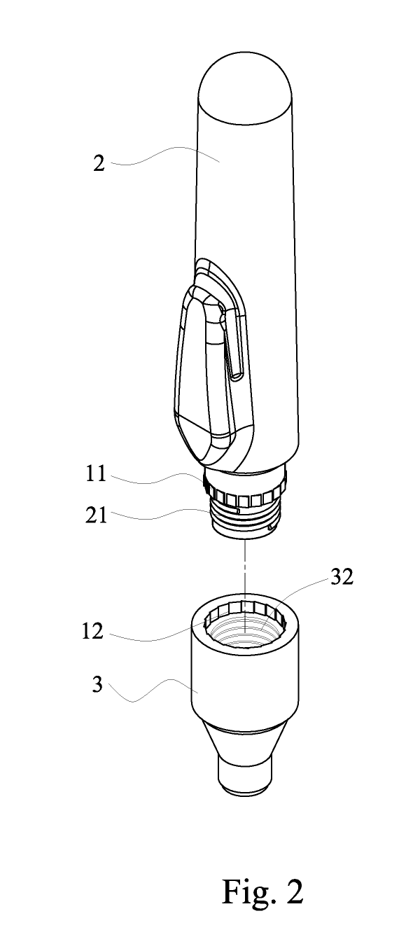

FIG. 2 is a schematic view in accordance with a second embodiment of the present invention. As shown in FIG. 2, in the second embodiment, the first ratchet portion 11 is located in proximity to the first threaded portion 21 and away from an opening of the stationery container 2. The second ratchet portion 12 is located on the cover 3 and close to an opening of the cover 3. A section between the first ratchet portion 11 and the first threaded portion 21 as well as a section between the second ratchet portion 12 and the second threaded portion 32 are formed with a step configuration because of different diameters. The operation to assemble the second embodiment and the retaining effect are substantially similar to the first embodiment.

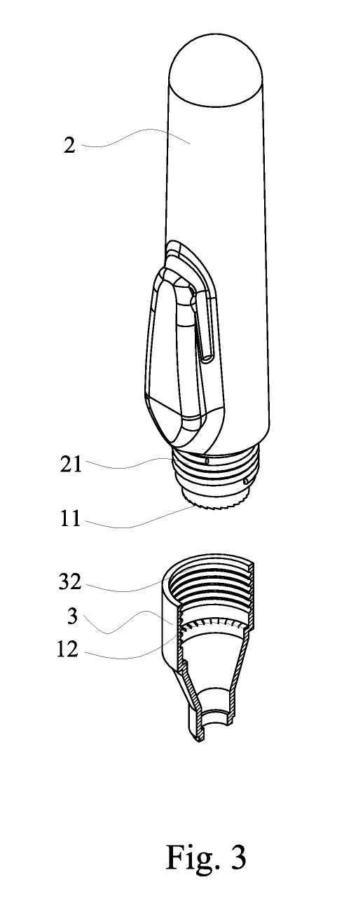

FIG. 3 is a schematic view in accordance with a third embodiment of the present invention. As shown in FIG. 3, in the third embodiment, the first ratchet portion 11 is located at an end face of the stationery container 2. The second ratchet portion 12 is located between the second threaded portion 32 and a fluid drain valve 31. When the cover 3 is screwed to the stationery container 2 to the end, the first ratchet portion 11 and the second ratchet portion 12 will mesh with each other to be locked.

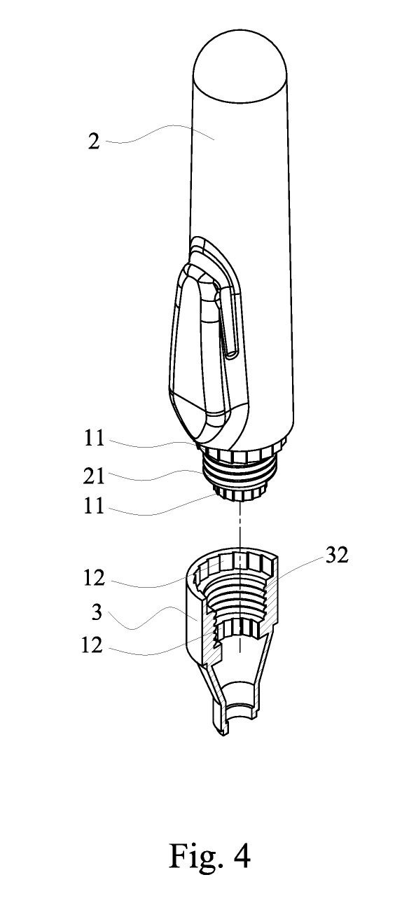

FIG. 4 is a schematic view in accordance with a fourth embodiment of the present invention. As shown in FIG. 4, in the fourth embodiment, the first ratchet portion 11 is arranged in the form of two sections and disposed at opposite sides of the first threaded portion 21 respectively. The second ratchet portion 12 is arranged in the form of two sections and disposed at opposite sides of the second threaded portion respectively 32. The first ratchet portion 11 and the first threaded portion 21 as well as the second ratchet portion 12 and the second threaded portion 32 have different diameters form a three-step step configuration. The operation to assemble the fourth embodiment is substantially similar to the first embodiment and the second embodiment. Because the first ratchet portion 11 and the second ratchet portion 12 are in the form of two sections, the engagement area is increased to enhance the lock force.

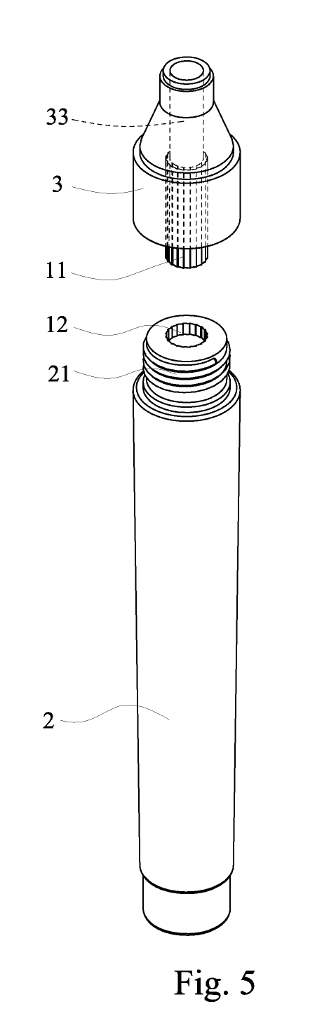

FIG. 5 is a schematic view in accordance with a fifth embodiment of the present invention. As shown in FIG. 5, the fifth embodiment of the present invention is modified greatly. The cover 3 has an inner tube 33 therein. The inner tube 33 is inserted into the opening of the stationery container 2 to from a secondary leakage-proof means, which is a normal design for the stationery container 2 to contain the correction fluid. The first ratchet portion 11 is disposed on an outer wall surface of the inner tube 33, and the second ratchet portion 12 is disposed on an inner wall surface of the stationery container 2. When the cover 3 is screwed to the stationery container 2, the first ratchet portion 11 and the second ratchet portion 12 will mesh with each other to provide a lock effect.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An anti-reversal structure of a stationery container and a cover, the cover having a second threaded portion screwed to a first threaded portion of the stationery container to seal the stationery container for containing a functional solution, the cover having a fluid outlet, the anti-reversal structure comprising:
a first ratchet portion disposed at one side of the first threaded portion, one surface of the first ratchet portion being a first guide surface corresponding in direction to a screw-in direction of the first threaded portion, another surface of the first ratchet portion being a first stop surface corresponding in direction to a screw-out direction of the first threaded portion; and
a second ratchet portion disposed at one side of the second threaded portion and corresponding to the first ratchet portion, one surface of the second ratchet portion being a second guide surface corresponding in direction to a screw-in direction of the second threaded portion, another surface of the second ratchet portion being a second stop surface corresponding in direction to a screw-out direction of the second threaded portion, wherein when the cover is screwed to the stationery container, the first stop surface and the second stop surface hold against each other to be locked, preventing the cover from reversal and disengagement.

2. The anti-reversal structure of a stationery container and a cover as claimed in claim 1, wherein the first threaded portion is located on an outer wall surface of the stationery container, and the second threaded portion is located on an inner wall surface of the cover.

3. The anti-reversal structure of a stationery container and a cover as claimed in claim 2, wherein the first ratchet portion is located in proximity to the first threaded portion and located close to an opening of the stationery container, the first ratchet portion and the first threaded portion have different diameters to form a step; the second ratchet portion is located on the cover between the second threaded portion and a fluid drain valve, and the second ratchet portion and the second threaded portion have different diameters to form a step.

4. The anti-reversal structure of a stationery container and a cover as claimed in claim 2, wherein the first ratchet portion is located in proximity to the first threaded portion and away from an opening of the stationery container, the first ratchet portion and the first threaded portion have different diameters to form a step; the second ratchet portion is located on the cover and close to an opening of the cover, and the second ratchet portion and the second threaded portion have different diameters to form a step.

5. The anti-reversal structure of a stationery container and a cover as claimed in claim 3, wherein a section between the first ratchet portion and the first threaded portion is step-like configuration, and a section between the second ratchet portion and the second threaded portion is another step-like configuration.

6. The anti-reversal structure of a stationery container and a cover as claimed in claim 4, wherein a section between the first ratchet portion and the first threaded portion is step-like configuration, and a section between the second ratchet portion and the second threaded portion is another step-like configuration.

7. The anti-reversal structure of a stationery container and a cover as claimed in claim 2, wherein the first ratchet portion is located at an end face of the stationery container, and the second ratchet portion is located between the second threaded portion and a fluid drain valve.

8. The anti-reversal structure of a stationery container and a cover as claimed in claim 2, wherein the first ratchet portion is arranged in the form of two sections and disposed at opposite sides of the first threaded portion respectively, the first ratchet portion and the first threaded portion have different diameters to form a step; the second ratchet portion is arranged in the form of two sections and disposed at opposite sides of the second threaded portion respectively, and the second ratchet portion and the second threaded portion have different diameters to form a step.

9. The anti-reversal structure of a stationery container and a cover as claimed in claim 8, wherein a section between the first ratchet portion and the first threaded portion is step-like configuration, and a section between the second ratchet portion and the second threaded portion is step-like configuration.

10. The anti-reversal structure of a stationery container and a cover as claimed in claim 1, wherein the cover has an inner tube therein, and the inner tube is inserted into an opening of the stationery container.

11. The anti-reversal structure of a stationery container and a cover as claimed in claim 10, wherein the first ratchet portion is disposed on an outer wall surface of the inner tube, and the second ratchet portion is disposed on an inner wall surface of an opening of the stationery container.
